(19) United States
(12) Patent Application Publication
(10) Pub. No.: US 2008/0179427 A1
(43) Pub. Date: Jul. 31, 2008

(54) Hand-held shower assembly

(76) Inventor: David J. Burke, Brick, NJ (US)

Correspondence Address: CARELLA, BYRNE, BAIN, GILFILLAN, CECCHI,;STEWART & OLSTEIN, 5 BECKER FARM ROAD, ROSELAND, NJ, 07068, US

(21) Appl. No.: 11/700,522

(22) Filed: Jan. 31, 2007

(51) Int. Cl. B05B 1/00; B29D 22/00

(52) U.S. Cl. 239/289; 239/532; 264/209.1; 264/299

(57) ABSTRACT

The components of a hand-held shower assembly, namely the hose and spray head, are each made of a polymeric material that has an antimicrobial additive embedded therein or coated on the water passages of each.

This invention relates to a hand-held shower assembly. More particularly, this invention relates to a hand-held shower assembly employing components with an embedded antimicrobial additive.

As is known, hand-held shower assemblies are typically fabricated with a hose that can be connected at one end to a valve in a shower stall and a spray head that can be connected to the opposite end of the hose for dispensing streams of water onto a user. Typically, the hose has been encased within a sheath of water repellant material. Generally, the hose is connected to a valve at an elevated height in the shower stall while the spray head is mounted on a vertically disposed wall bar via a slidable connection so that the height of the spray head can be adjusted for use. As a result, the hose forms a depending loop within which water may collect. Over time, the standing water in the loop creates a site for bacterial growth.

Accordingly, it is an object of this invention to prevent the growth of bacteria in the hose of a hand-held shower assembly.

It is another object of the invention to prevent the growth of bacteria in a spray head of a hand-held shower assembly.

Briefly, the invention provides a hand-held shower assembly with components that are manufactured with an antimicrobial additive embedded therein. In particular, the shower assembly is provided with a hose that is made of a flexible polymeric material having an antimicrobial additive embedded therein as well as a spray head that is made of a polymeric material having an antimicrobial additive embedded therein.

In an alternative embodiment, the hose and/or the spray head may have the water conveying passages of each provided with an antimicrobial additive.

The antimicrobial additive in the polymeric material is preferably an inorganic silver ion exchange system. In addition, the additive may include an inorganic copper and/or zinc.

The amount of additive in the polymeric material constitutes 1% to 5% by weight of the total weight of the component, i.e. hose or spray head. In this respect, an amount of less than 1% of an additive is insufficient to have an antimicrobial effect.

In order to make a hose in accordance with the invention, the antimicrobial additive is compounded into various polymers by up to 40% by weight with the exact correct additive being specified for each polymer. Compounding takes place in an extruder in which the base polymer is melted and the additive introduced into the polymer melt stream, for example through a side feed in the extruder. The extrudate extruded from the extruder is pelletized and collected into a mass of pellets in which the additive constitutes an amount of from 10% to 40% by weight of the mass. This resulting master batch is then mixed with virgin polymer of the same type as in the mixture to achieve a mixture in which the antimicrobial additive is an amount of 1% to 5% by weight of the mixture. For example, the mixture may be obtained by blending of the master batch and the virgin polymer in a drum roller for 1 hour, capped with nitrogen, if possible to keep the mixture dry.

Thereafter, using a closed feeding system or sealed hopper to avoid contamination, the mixture is extruded through a suitably shaped die to form a hose having a longitudinal passageway for a flow of water.

In order to form a spray head, the mixture is injection molded in a die to form the spray head with at least one passage for a flow of water.

Depending on the polymer used, the amount of additive may be different. Suitable polymeric materials include polyvinyl chloride (PVC) polyacetal, polyamide (Nylon), polycarbonate, low-density polyethylene, acrylonite butadiene styrene (ABS), a thermoplastic vulcanizate (Santoprene) and Rotomold polyethylene (PE).

These and other objects and advantages of the invention will become more apparent from the following detailed description taken in conjunction with the accompanying drawings wherein:

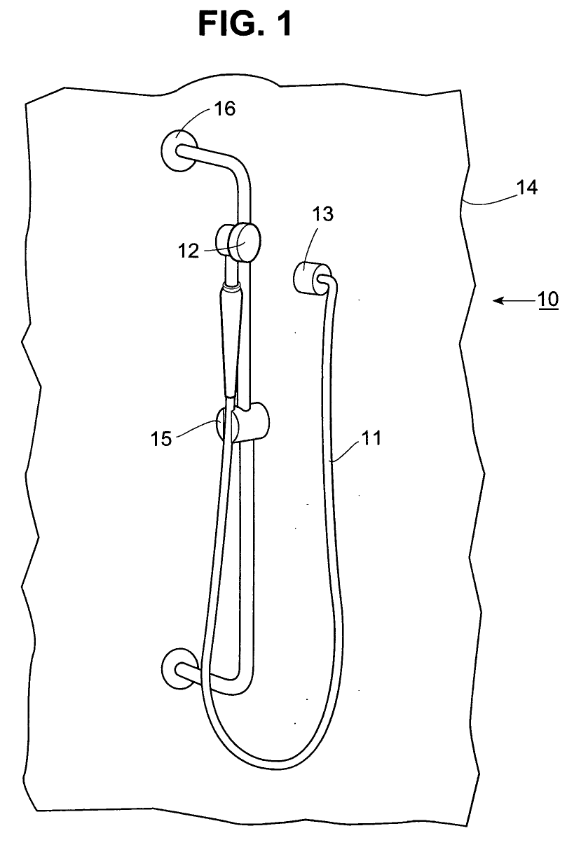

FIG. 1 illustrates a view of a hand-held shower assembly constructed in accordance with the invention;

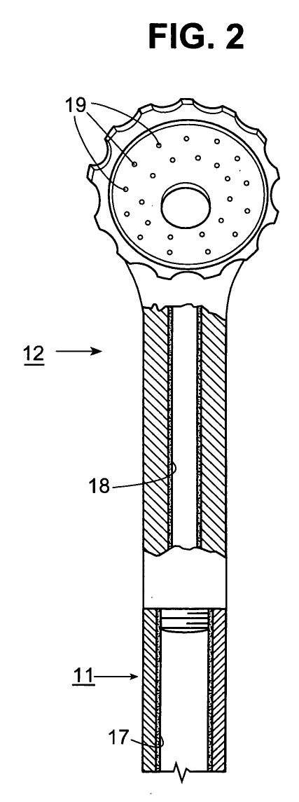

FIG. 2 illustrates a part-cross sectional view of a spray head in accordance with the invention.

Referring to FIG. 1, the hand-held shower assembly 10 includes a hose 11 and a spray head 12 connected to the hose 11.

In particular, the hose 11 has an inlet end for connection to a water conveying means, such as a tap 13, located at an elevated position in a wall 14 of a shower stall. The outlet end of the hose 11 is connected to the spray head 12 to deliver water thereto in known manner. The hose 11 has an inner annular surface 17 that defines a passage for a flow of water to the spray head 12.

Referring to FIG. 2, the spray head 12 is of any conventional shape and includes a passage 18 to receive a flow of water from the hose 11 at one end and a plurality of outlets 19 at the opposite end for discharging streams of water in a conventional fashion.

As Illustrated in FIG. 1, the shower assembly 10 includes a connector 15 in the form of a clip, or the like, that is slidably mounted on a vertical wall bar 16 and releaseably attached to the spray head 12 to allow a user to slide the spray head 12 into different vertical positions to accommodate the user or to remove the spray head to allow the user to hold the spray head by hand.

When the shower assembly 10 is not in use, the spray head 12 is held by the connector 15 on the wall bar 16. In this position, the hose 11 forms a loop as indicated. Typically, water collects at the bottom of the loop of the hose 11 and, over time, may provide a site for the collection and growth of bacteria.

In accordance with the invention, the hose 11 is made of a flexible polymeric material that has an antimicrobial additive embedded therein. The hose 11 may also be surrounded by a sheath or plastic covering in a conventional manner.

The antimicrobial additive is an trimodal efficacy of an inorganic silver ion exchange system.

The antimicrobial additive constitutes to 1% to 5% by weight of the total weight of the hose 11. In addition, the additive may conclude at least of 1% of an inorganic copper and/or zinc.

In order to form a hose, an antimicrobial additive master batch is first prepared. In this respect, the antimicrobial additive is extremely hydroscopic and will absorb a significant amount of moisture if left exposed to the air. Hence, the additive is maintained in a dry state and is processed in a dry state.

The additive is thermally stable up to 800° C. and maybe dried with heat.

The resin selected to make the master batch should be the same resin used in the final product.

During processing, the base resin is melted, for example, using a twin-screw extruder utilizing a mid- to low-screw speed and melting temperatures. The antimicrobial is introduced into the polymer melt stream, for example, through a side feed located approximately half way down the extruder barrel. Upon extrusion, the extrudate that consists of the base resin and the additive is pelletized in a suitable manner and immediately collected and sealed in a shipping container or returned to a desiccant dryer. The resulting master batch contains from 10% to 40% by weight of the antimicrobial additive.

In one embodiment, the master batch is blended with the virgin resin at a ratio to form a mixture wherein the additive constitutes an amount from 1% to 5% by weight of the mixture. Blending may be carried out in a drum roller for 1 hour with the mixture being maintained in a dry condition.

After blending, the resulting mixture is extruded in a suitable extruder to form a hose 11 having an internal annular surface defining a passage for a flow of water. Alternatively, the mixture may be injected into a injection molding apparatus in order to mold a spray head 12 having at least one passage for a flow of water.

The antimicrobial additive that is embedded within the hose 11 acts to stop the growth of any bacteria that may otherwise collect or form within the water passage of the hose 11.

Since the antimicrobial additive is embedded in the hose 11, the additive will not dissipate over time or become eroded over time.

Referring to FIG. 2, each of the hose 11 and spray head 12 may be provided with the antimicrobial embedded in the polymeric material used to make the hose 11 and spray head 12.

Alternatively, the antimicrobial additive may be applied as a powder coating on the passage 17 of the hose 11 and/or the passage 18 of the spray head 12. For example there are low temperature and UV light cure products that can treat plastic with a conductive material. Also, a metal shower head may be treated with the antimicrobial additive.

The thickness of a coating of the antimicrobial additive is a range of 0.001 inches to 0.030 inches.

The invention thus provides a simple technique for stopping bacterial growth within the water conveying elements of a hand-held showerhead assembly. Further, the invention allows the internal surfaces of a hand-held shower assembly that cannot be cleaned by traditional methods to be protected by the antimicrobial additive.

What is claimed is:

1. A hand-held shower assembly comprising
a hose having an inlet end for connection to a water conveying means, said hose being made of a flexible polymeric material having an antimicrobial additive embedded therein; and
a spray head connected to an outlet end of said hose for receiving a flow of water therefrom.

2. A shower assembly as set forth in claim 1 wherein said antimicrobial additive constitutes from 1% to 5% by weight of the total weight of said hose.

3. A shower assembly as set forth in claim 1 wherein said additive is an inorganic silver ion exchange system.

4. A shower assembly as set forth in claim 3 further comprising at least one of an inorganic copper and zinc in said additive.

5. A shower assembly as set forth in claim 1 wherein said spray head is made of a polymeric material having an antimicrobial additive embedded therein.

6. A shower assembly as set forth in claim 5 wherein said additive in said shower head is an inorganic silver ion exchange system.

7. A shower assembly as set forth in claim 1 wherein said polymeric material is selected from the group consisting of polyvinylchloride, polyacetal, polyamide, polycarbonate, low density polyethylene, acrylonite butadiene styrene (ABS), a thermoplastic vulcanizate and polyethylene.

8. A hand-held shower assembly comprising
a hose having an inlet end for connection to a water conveying means, said hose being made of a flexible polymeric material having an internal annular surface defining a passage for a flow of water therethrough;
an antimicrobial powder coating on said annular surface; and
a spray head connected to an outlet end of said hose for receiving a flow of water therefrom.

9. A shower assembly as set forth in claim 8 wherein said antimicrobial additive constitutes from 1% to 5% by weight of the total weight of said hose.

10. A shower assembly as set forth in claim 8 wherein said additive is an inorganic silver ion exchange system.

11. A shower assembly as set forth in claim 10 further comprising at least one of an inorganic copper and zinc in said additive.

12. A shower assembly as set forth in claim 8 wherein said spray head is made of a polymeric material and has at least one passageway for a flow of water and an antimicrobial additive coated on said passageway.

13. A shower assembly as set forth in claim 12 wherein said additive in said shower head is an inorganic silver ion exchange system.

14. A method of making a hose for a hand-held shower assembly comprising the steps of
obtaining a mass of pellets of a polymer material wherein said pellets contain an antimicrobial additive to in an amount of from 10% to 40% by weight of said mass;
mixing said mass with an additional amount of said polymer material to form a mixture wherein said additive constitutes an amount of from 1% to 5% by weight of said mixture; and
extruding said mixture through a die to form a hose having a longitudinal passageway for a flow of water therethrough.

15. A method of making a spray head comprising the steps of
obtaining a mass of pellets of a polymer material wherein said pellets contain an antimicrobial additive to in an amount of from 10% to 40% by weight of said mass;
mixing said mass with an additional amount of said polymer material to form a mixture wherein said additive constitutes an amount of from 1% to 5% by weight of said mixture; and
injection molding said mixture in a mold to form a spray head having at least one passageway for a flow of water.
